(19) United States
(12) Patent Application Publication
(10) Pub. No.: US 2025/0329836 A1
(43) Pub. Date: Oct. 23, 2025

(54) BATTERY MODULE, BATTERY SYSTEM, ELECTRIC VEHICLE, METHOD FOR ASSEMBLING A BATTERY MODULE AND HOUSING

(71) Applicant: SAMSUNG SDI CO., LTD., Yongin-si (KR)

(72) Inventor: Thomas Burke, Ligist (AT)

(21) Appl. No.: 18/825,867

(22) Filed: Sep. 5, 2024

(30) Foreign Application Priority Data
Apr. 23, 2024 (EP) 24171864.2

(51) Int. Cl. H01M 50/209; B60L 50/64; H01M 10/613; H01M 10/625; H01M 10/647; H01M 10/6554; H01M 50/242; H01M 50/271; H01M 50/342

(52) U.S. Cl. CPC H01M 50/209; B60L 50/64; H01M 10/613; H01M 10/625; H01M 10/647; H01M 10/6554; H01M 50/242; H01M 50/271; H01M 50/3425; H01M 2220/20

(57) ABSTRACT

A battery module including a battery cell stack including a plurality of battery cells arranged in a stacking direction and a housing configured to accommodate the battery cell stack. The housing includes a bottom portion; a top portion; two side portions arranged opposite to each other in the stacking direction and interconnecting the bottom portion and the top portion in a height direction; and a side opening through which the battery cell stack is insertable into the housing in an insertion direction, the insertion direction being orthogonal to the stacking direction and being orthogonal to the height direction. The top portion includes an opened section overlaying the electrode terminals and the venting valves of the plurality of battery cells of the battery cell stack when the battery cell stack is accommodated in the housing.

### CROSS REFERENCE TO RELATED APPLICATION

The present application claims priority to and the benefit of European Patent Application No. 24171864.2, filed on Apr. 23, 2024, in the European Patent Office, the entire disclosure of which is incorporated herein by reference.

### BACKGROUND

### 1. Field

Aspects of embodiments of the present disclosure relate to a battery module, a battery system including the battery module and an electric vehicle including the battery module and/or the battery system. Additional aspects of embodiments of the present disclosure relate to a method for assembling the battery module and a housing configured to accommodate a battery cell stack.

### 2. Description of the Related Art

Recently, vehicles (e.g., vehicles for transportation of goods and people) have been developed that use electric power as a source for motion. An electric vehicle is an automobile that is propelled permanently or temporarily by an electric motor that uses energy stored in rechargeable (or secondary) batteries. An electric vehicle may be powered by batteries (such as in a battery electric vehicle (BEV)) or may include a combination of an electric motor and, for example, a combustion engine (such as in a plugin hybrid electric vehicle (PHEV)). BEVs and PHEVs use high-capacity rechargeable batteries, which are designed to give power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located in a casing, and electrode terminals, which are positioned on the outside of the casing, establish an electrically conductive connection to the electrodes. The shape of the casing may be, for example, cylindrical or rectangular.

A battery main module is formed of a plurality of battery cells connected together in series and/or in parallel. For example, the battery main module is formed by interconnecting the electrode terminals of the plurality of battery cells depending on a required or desired amount of power and to realize a high-power rechargeable battery.

Battery main modules can be constructed either in a block design or in a modular design. In the block design, each battery cell is coupled to a common current collector structure and a common battery management system and the unit thereof is arranged in a housing. In the modular design, pluralities of battery cells are connected together to form (sub)modules and several (sub)modules are connected together to form the battery main module. In automotive applications, battery systems may consist of a plurality of battery (sub)modules and/or battery main modules connected to each other in series to provide a desired voltage.

A mechanical integration of a battery main module requires appropriate mechanical connections between the individual components, e.g. of battery modules, and between them and a supporting structure of the vehicle. These connections must remain functional and protected during the average service life of the battery system. Further, installation space and interchangeability requirements must be met, especially in mobile applications.

The mechanical integration of battery modules may be achieved by providing a carrier framework and by positioning the battery modules thereon. Fixing the battery cells or battery modules may be achieved by fitted depressions in the framework or by mechanical interconnectors such as bolts or screws. Alternatively, the battery modules are confined by fastening side plates to lateral sides of the carrier framework. Further, cover plates may be fixed atop and below the battery modules.

The carrier framework of the battery main module is mounted to a carrying structure of the vehicle. In some cases, the battery main module shall be fixed at the bottom of the vehicle, and the mechanical connection may be established from the bottom side by, for example, bolts passing through the carrier framework of the battery main module. The framework can be made of aluminum or an aluminum alloy to lower the total weight of the construction.

To reduce the manufacturing cost of battery modules, one conventional battery module includes a battery cell stack, a mono frame with an open front surface and an open rear surface and end plates for covering the open front surface and the rear surface of the mono frame. The battery module is horizontally assembled by inserting the battery cell stack into the open front surface or the open rear surface of the mono frame and covering the open front surface and the open rear surface by end plates.

However, despite improvements in the art, the manufacturing of the battery systems is still cumbersome, cost-intensive and the design of the battery module housings is limited due to required or desired mechanical resilience properties for reducing the risks of bending of the housing during stacking or during use of the battery system. During the operation of a battery system, the battery cells are heated and inflate as a result of a chemical reaction, thereby causing a force on the housing which bends the housing. The bending of the housing impairs the service life of at least the battery cells next to the bent housing and may further lead to other unexpected effects which, in turn, may lead to a weakening of the entire battery system.

Accordingly, an aspect of the present disclosure may provide a simplified battery module with an increased service life.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to one or more embodiments of the present disclosure, a battery module includes a battery cell stack with a plurality of battery cells arranged in a stacking direction; and a housing configured to accommodate the battery cell stack. The housing incudes a bottom portion, a top portion, two side portions arranged opposite to each other in the stacking direction and interconnecting the bottom portion and the top portion in a height direction and a side opening through which the battery cell stack is insertable into the housing in an insertion direction, the insertion direction being orthogonal to the stacking direction and being orthogonal to the height direction. The top portion has an opened section overlaying the electrode terminals and the venting valves of the plurality of battery cells of the battery cell stack.

According to one or more embodiments of the present disclosure, a battery system includes a plurality of the battery modules arranged adjacent to each other.

According to one or more embodiments of the present disclosure, an electric vehicle includes the battery module and/or the battery system.

According to one or more embodiments of the present disclosure, a method for assembling a battery module includes: f arranging a plurality of battery cells in a stacking direction to form a battery cell stack; and inserting the battery cell stack into a housing, wherein the housing includes a bottom portion, a top portion, two side portions arranged opposite to each other in the stacking direction and interconnecting the bottom portion and the top portion in a height direction, and a side opening through which the battery cell stack is insertable into the housing in an insertion direction, the insertion direction being orthogonal to the stacking direction and being orthogonal to the height direction, wherein the top portion includes an opened section overlaying the electrode terminals and the venting valves of the plurality of battery cells of the battery cell stack.

One or more embodiments of the present disclosure include a housing configured to accommodate a battery cell stack including a plurality of battery cells, the housing including a bottom portion; a top portion; and two side portions arranged opposite to each other in a stacking direction of a plurality of battery cells of the battery cell stack and interconnecting the bottom portion and the top portion in a height direction, and a side opening through which the battery cell stack is insertable into the housing in an insertion direction, the insertion direction being orthogonal to the stacking direction and being orthogonal to the height direction, wherein the top portion includes an opened section overlaying electrode terminals and venting valves of the plurality of battery cells of the battery cell stack.

Further aspects of the present disclosure are described in more detail in the claims and/or in the following description.

### BRIEF DESCRIPTION OF THE DRAWINGS

Features will become apparent to those of ordinary skill in the art by describing in more detail example embodiments with reference to the attached drawings in which:

FIG. 1 is a schematic perspective view of a battery module according to one or more embodiments in a first configuration.

FIG. 2 is a schematic perspective view of the battery module of FIG. 1 in a second configuration.

FIG. 3 is a schematic enlarged view of III shown in FIG. 2.

FIG. 4 is a schematic perspective view of a housing according to one or more embodiments.

FIG. 5 is a schematic cross-sectional of the housing shown in FIG. 4.

FIG. 6 is a schematic perspective view of the battery system including four battery modules shown in FIG. 1.

FIG. 7 is a schematic flow chart of a method for assembling the battery module shown in FIG. 1 according to one or more embodiments.

### DETAILED DESCRIPTION

Reference will now be made in more detail to one or more embodiments, examples of which are illustrated in the accompanying drawings. Aspects and features of the embodiments, and implementation methods thereof will be described in more detail with reference to the accompanying drawings. In the drawings, like reference numerals denote like elements, and redundant descriptions are not provided. The present disclosure, however, may be embodied in one or more suitable different forms, and should not be construed as being limited to only the illustrated embodiments herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described or may be only briefly described. In the drawings, the relative sizes of elements, layers, and regions may be exaggerated for clarity.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The reference to two objects of comparison being “the same” means “substantially the same”. Therefore, “the same” or “substantially the same” may include a deviation that is considered as a low level in the art, for example, a deviation of less than 5%. In addition, uniformity of a parameter at a certain area may mean uniformity from an average perspective.

It will also be understood that when a film, a region, or an element is referred to as being “above” or “on” another film, region, or element, it can be directly on the other film, region, or element, or intervening films, regions, or elements may also be present.

Herein, the terms “upper” or “top” and “lower” or “bottom” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

In the following description of embodiments of the present disclosure, the terms of a singular form may include plural forms unless the context clearly indicates otherwise.

The electronic or electric devices and/or any other relevant devices or components according to one or more embodiments of the present disclosure described herein may be implemented utilizing any suitable hardware, firmware (e.g. an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, e.g. on a PCB or another kind of circuit carrier. The conducting elements may include metallization, e.g. surface metallizations and/or pins, and/or may include conductive polymers or ceramics. Further electrical energy might be transmitted via wireless connections, e.g. using electromagnetic radiation and/or light.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one or more embodiments of the present disclosure, a battery module includes a battery cell stack and a housing. The battery cell stack includes a plurality of battery cells arranged in a stacking direction. The housing is configured to accommodate the battery cell stack.

The housing includes a bottom portion, a top portion and two side portions. The side portions are arranged opposite to each other in the stacking direction and interconnect the bottom portion and the top portion in a height direction (e.g. a height direction is a direction of the height of the battery cells of the battery cell stack). The side portions interconnect a first end of the bottom portion and a first end of the top portion and interconnect a second end of the bottom portion, the second end of the bottom portion being arranged opposite to the first end of the bottom portion in the stacking direction, and a second end of the top portion, the second end of the top portion being arranged opposite to the first end of the top portion in the stacking direction. The bottom portion may correspond to a bottom of the housing. The side portions may include (e.g., may be formed as) lateral walls extending from the bottom portion to the top portion. The top portion may correspond to a top cover of the housing.

The housing further includes a side opening through which the battery cell stack is insertable into the housing in an insertion direction (or in a direction opposite to the insertion direction which will not be repeated but considered as well in the following disclosure). The insertion direction is orthogonal to the stacking direction and orthogonal to the height direction. For example, the battery cell stack is inserted sideward into the housing through the side opening. In other words, the housing provides a structure enclosing an inserted battery cell stack, when viewed in the insertion direction. For example, the housing is a closed structure, e.g. a closed frame, with an insertion opening (the side opening), when viewed in the insertion direction. Due to this structure, bending of the side portions in the stacking direction, e.g. during assembly or operation of the battery module, may be prevented or at least reduced. At the side of the housing arranged opposite to the side opening in the insertion direction, the housing may be closed, e.g. closed by a wall extending from the bottom portion to the top portion in the height direction. Due to the closure of the side opposite to the side opening, the wall may act as a barrier when the battery cell stack is inserted into the housing. Accordingly, the assembly thereof is facilitated and the robustness of the battery module may be enhanced. For example, the housing may include another side opening at the side opposite to the side opening in the insertion direction and through which the battery cell stack is insertable the housing in the insertion direction. The side openings may be formed identically or nearly identically. Accordingly, the battery cell stack is insertable into the housing from both sides (e.g., opposite sides), thereby facilitating the assembly of the battery module. In addition, less space along the insertion direction may be required or desired. In other words, the length of the battery cell stack may correspond to the length of the housing with respect to the insertion direction such that the battery cell stack may be flush with the housing. Accordingly, a more compact battery module may be formed. The length of the housing in the insertion direction may important such that the battery cell stack may be accommodated entirely in the housing, at least in the insertion direction.

The top portion includes an opened section overlaying the electrode terminals and the venting valves of the plurality of battery cells of the battery cell stack when the battery cell stack is accommodated in, i.e. inserted into, the housing. In other words, the opened section is configured such that the electrode terminals and the venting valves of the plurality of battery cells of the accommodated battery cell stack are exposed when viewed from above, i.e. viewed from the top portion of the housing. Due to the exposure of the functional areas of the battery cells, i.e. the electrode terminals and the venting valves, the electrode terminals may be connected subsequently and the venting valves are not blocked by the housing in case of a venting event in which the venting of the battery cell via the venting valve is required or desired. The opened section is encompassed by the top portion in the insertion direction, e.g. by bars extending between the side portions in the stacking direction. In other words, despite the opened section providing access to the functional areas of the battery cells, the top portion increases rigidity and stiffness of the housing against potential bending of the side portions. Accordingly, bending of the side portions of the housing can be prevented or at least reduced and, thus, the service life of the battery module can be increased.

According to one or more embodiments, the opened section may include a slit-like opening extending through the top portion in the stacking direction and overlaying each of the electrode terminals and the venting valves of the plurality of battery cells of the battery cell stack when the battery cell stack is accommodated in the housing. In other words, the slit-like opening has a size that allows all of the functional areas, i.e. the electrode terminals and the venting valves, of the battery cells of the battery cell stack to be exposed when viewed from above, i.e. viewed from the top portion. Accordingly, at least one opening has to be provided into the top portion to provide the functionality, thereby facilitating the manufacturing of the battery module. Although reference is made to a slit-like opening, the shape of the opening is not limited thereto and may have different shapes such as a circular shape, an ellipsoidal shape, a rhombic shape, and/or the like. Many battery cells have a rectangular shape, e.g. squared shape or cuboid shape (prismatic cells), and are arranged in a line in the stacking direction such that straight rows of electrodes and venting valves are formed. Accordingly, the slit-like openings are efficient for exposing the electrodes and venting valves, while providing rigidity and stiffness of the housing against potential bending of the side portions.

According to one or more embodiments, the opened section may include three slit-like openings extending through the top portion in the stacking direction. Two slit-like openings of the three slit-like openings may (e.g., be formed to) overlay the electrode terminals, i.e. one slit-like opening overlaying each row of electrode terminals, and the remaining slit-like opening of the three slit-like openings may (e.g., be formed to) overlay the venting valves of the plurality of battery cells of the battery cell stack when the battery cell stack is accommodated in the housing. In other words, the top portion of the housing may include one or more bars extending between the side portions in the stacking direction and being arranged between the slit-like openings. The bars further increase the rigidity and stiffness of the housing against potential bending of the side portions, while still exposing the electrode terminals and the venting valves when viewed from above, i.e. viewed from the top portion. The slit-like openings may be arranged parallel to each other. Although reference is made to slit-like openings, the shapes of the openings are not limited thereto and may have different shapes, such as a circular shape, an ellipsoidal shape, a rhombic shape, and/or the like.

According to one or more embodiments, the opened section may extend entirely through the top portion in the stacking direction. In one or more embodiments, the opened section may partially extend through the side portions. Accordingly, the manufacturing of the housing may be facilitated. In one or more embodiments, a horizontal venting channel, i.e. in the stacking direction, may partially extend through the side portions such that no additional space is required or desired in the height direction for discharging venting gas out of the battery module.

According to one or more embodiments, the battery cell stack may include a force distribution plate and a compressible elastic element arranged at each end (e.g., opposite ends) of the battery cell stack in the stacking direction. In other words, both ends of the battery cell stack in the stacking direction are covered or encompassed by a force distribution plate. The force distribution plates may have a shape that substantially corresponds to the size of the battery cells of the battery cell stack when viewed in the stacking direction. Accordingly, the battery cell stack may be handled by contacting the distribution plates without the battery cell stack being damaged. The compressible elastic elements may be on the outer surface of the distribution plates with respect to the stacking direction. At least one of the compressible elastic elements may be a spring. The compressible elastic elements may be compressed when handling the battery cell stack at the force distribution plates such that the extension of the battery cell stack in the stacking direction is reversibly reduced until the battery cell stack is accommodated in the housing, where the compressible elastic element provides a restoration or opposing force against the side portions of the housing to ensure a firm seating of the accommodated battery cell stack. Accordingly, the assembly of the battery module is facilitated and the service life thereof is improved.

The compressible elastic elements may include degressive springs. At the beginning of compression, degressive springs are compressible by applying a relatively low force, while the amount of force necessary to further compress the spring is increasing during compression. Therefore, the extension of the battery cell stack in the stacking direction may be reduced relatively easily when inserting the battery cell stack into the housing to assemble the battery module. When the battery cell stack is accommodated in the housing, further compressing of the degressive springs requires or desires an increasing amount of force to improve the firm seating of the accommodated battery cell stack.

According to one or more embodiments, each of the side portions of the housing may include a recess for receiving the compressed elastic element. The recesses provide further space for inserting the battery cell stack into the housing, thereby further facilitating the assembly of the battery module. Each of the recesses may have a depth of more than 5 percent and/or less than 30 percent, less than 20 percent and/or less than 10 percent of the thickness of the side portion in the stacking direction. For example, the housing and the recesses may be designed such that the compressible elastic elements are compressed when the battery cell stack is accommodated in the housing. For example, the compressible elastic elements may be compressed by at least 10 percent and/or up to 75 percent, up to 50 percent or up to 25 percent with respect to the length of the compressible elastic element in a rest position (e.g., when the compressible elastic elements are not compressed).

According to one or more embodiments, the housing may include a cooling plate arranged on the bottom portion. The cooling plate enhances heat dissipation. The cooling plate may be arranged on an inner side of the bottom portion. In other words, the cooling plate may be arranged between the bottom portion of the housing and the accommodated battery cell stack. Accordingly, the transmission of heat in the battery module, e.g. heat generated by the operation of the battery cells, towards the outside of the battery module is further enhanced due to the positioning, thereby reducing the amount of swelling of the battery cells, and, thus, reducing the amount of bending of the side portions of the housing.

According to one or more embodiments, the bottom portion, the top portion and the side portions of the housing may be integrally formed. In other words, the housing may be integrally formed. For example, the housing may be extruded and, optionally, mechanically processed, e.g. to include the opened section in the top portion. Integrally formed structures provide further rigidity and stiffness of the housing against potential bending of the side portions. In one or more embodiments, the bottom portion, the top portion and the side portions of the housing may be connected to each other in a fabric-conclusive manner. In other words, the bottom portion, the top portion and the side portions may be separative parts, e.g. extruded separate parts, which are connected to each other in a subsequent step, e.g. to form a woven fabric.

According to one or more embodiments, the housing may include (e.g., may be made of) plastics or a hybrid combination including plastics. Due to the closed structure of the housing, the rigidity and stiffness thereof are increased to such an extent that materials with less mechanical resilience as compared to other metals used in the art, such as aluminum, may be used. In contrast to metals, plastics are insulating, thereby reducing the risk of current leakage or short circuiting.

According to one or more embodiments, the top portion may include a convex shape. In other words, the middle section of the top portion in the stacking direction may have a thickness greater than a thickness of the ends of the top portion (e.g., end portions of the top portion). Due to the convex shape, the risk of the side portions bending may be further reduced. The top portion may include a single convex shape arranged at one surface, e.g. the inner surface or the outer surface, or a double convex shape arranged on both of its surfaces (e.g., opposite surfaces), namely the inner and the outer surface. The convex shape may be formed such that the middle section of the top portion in the stacking direction may have a thickness at least 5 percent or at least 10 percent and/or less than 100 percent, less than 75 percent, less than 50 percent or less than 25 percent greater than a thickness of the ends of the top portion.

The present disclosure also includes a battery system including a plurality of battery modules according to one or more embodiments of the present disclosure arranged adjacent to each other. For example, the battery system may be a traction battery. The plurality of battery modules may be arranged adjacent to each other in a modular manner, e.g. a grid-like arrangement. In other words, the battery modules may be arranged adjacent to each other in the stacking direction and/or in the insertion direction. Accordingly, a cost-effective and space saving battery system with high service life may be provided.

The present disclosure also includes an electric vehicle including a battery module according to one or more embodiments of the present disclosure and/or a battery system according to one or more embodiments of the present disclosure.

Further, the present disclosure refers to a method for assembling a battery module, namely the above-mentioned battery module.

According to a step of the method, a battery cell stack is formed by arranging a plurality of battery cells in a stacking direction.

According to another step of the method, a housing configured to accommodate the battery cell stack is provided. The housing includes a bottom portion; a top portion; two side portions arranged opposite to each other in the stacking direction and interconnecting the bottom portion and the top portion in a height direction; and a side opening through which the battery cell stack is insertable into the housing in an insertion direction, the insertion direction being orthogonal to the stacking direction and being orthogonal to the height direction. The top portion includes an opened section overlaying the electrode terminals and the venting valves of the plurality of battery cells of the battery cell stack when the battery cell stack is accommodated in the housing.

According to another step of the method, the battery cell stack is inserted into the housing through the side opening in the insertion direction.

According to a step of the method, the electrode terminals of each row of the electrode terminals of the plurality of battery cells of the accommodated battery cell stack may be interconnected. In one or more embodiments, the electrode terminals of the battery cells of the battery cell stack may be interconnected prior to insertion into the housing. In other words, the electrode terminals of the battery cells of the provided battery cell stack may already be interconnected.

According to another step of the method, the inserting of the battery cell stack may include the steps of compressing the compressible elastic members of the battery cell stack, for example with a pliers device, and positioning the compressed battery cell stack into the housing.

The present disclosure also includes a housing configured to accommodate a battery cell stack. The housing includes a bottom portion; a top portion; two side portions arranged opposite to each other in a stacking direction of the battery cells of the battery cell stack and interconnecting the bottom portion and the top portion in a height direction; and a side opening through which the battery cell stack is insertable into the housing in an insertion direction, the insertion direction being orthogonal to the stacking direction and being orthogonal to the height direction. The top portion includes an opened section overlaying electrode terminals and venting valves of the battery cells of the battery cell stack when the battery cell stack is accommodated in the housing.

### Specific Embodiments

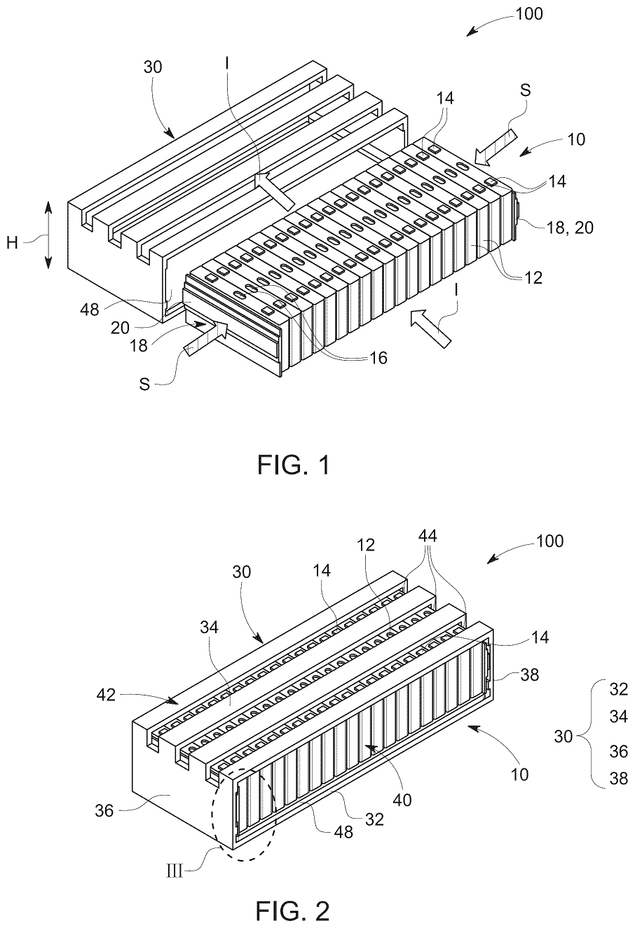

FIG. 1 is a schematic perspective view of a battery module 100 according to one or more embodiments in a first configuration. FIG. 2 illustrates a schematic perspective view of the battery module of FIG. 1 in a second configuration.

The battery module 100 includes a battery cell stack 10 and a housing 30 configured to accommodate the battery cell stack 10. In the first configuration, the battery cell stack 10 and the housing 30 are separated from each other. In the second configuration, the battery cell stack 10 is accommodated in the housing 30.

The battery cell stack 10 includes a plurality of battery cells 12 arranged in a stacking direction S. As shown in FIG. 1, the battery cells 12 may include prismatic cells, i.e. cells whose chemistry is enclosed in a rigid casing, but is not limited thereto. The battery cells 12 may have a rectangular shape, which allows the battery cells 12 to be efficiently stacked in the stacking direction S. For example, the shortest side of each battery cell 12 is arranged in a direction parallel to the stacking direction S. On the top surface, each battery cell 12 includes a pair of electrode terminals 14 arranged on opposite ends of the battery cell 12 in a direction orthogonal to the stacking direction S (e.g., insertion direction I, which is explained in more detail later in view of the housing 30). Each battery cell 12 further includes a venting valve 16 between the electrode terminals 14. Due to the stacked structure, the electrode terminals 14 and the venting valves 16 are arranged in respective rows extending in the stacking direction S.

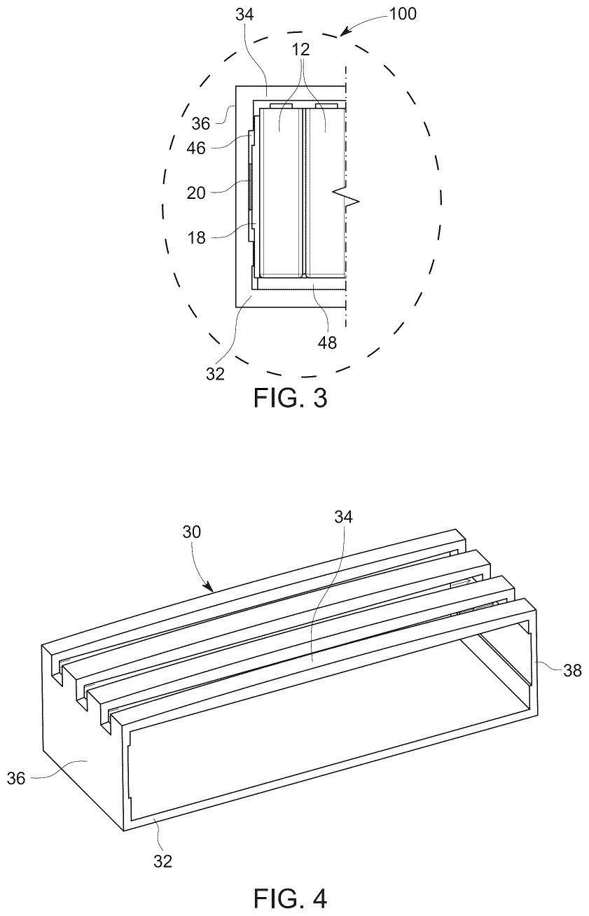

The battery cell stack 10 further includes a force distribution plate 18 and a compressible elastic element 20 each arranged at each of the ends (e.g., opposite ends) of the battery cell stack 10 in the stacking direction S. The force distribution plates 18 are formed and arranged such that a surface of the respective outer battery cell 12 of the battery cell stack 10 in the stacking direction S is substantially covered (e.g., entirely covered) by the force distribution plate 18. Accordingly, the battery cell stack 10 may be handled by contacting the distribution plates 18 without the battery cell stack 10 being damaged. The compressible elastic elements 20 may be degressive springs which are on the outer surface of the respective distribution plate 18 in stacking direction S. The compressible elastic elements 20 may be compressed during handling of the battery cell stack 10 at the force distribution plates 18, e.g. handling with a pliers device, such that the length of the battery cell stack 10 in the stacking direction S is reversibly reduced until the battery cell stack 10 can be accommodated in the housing 30 as explained in more detail later in view of FIG. 3. However, the present disclosure is not limited thereto and the force distribution plates 18 and the compressible elastic elements 20 may also not be provided.

Referring now to the housing 30 which will be described in more detail in view of FIG. 2. The housing 30 includes a bottom portion 32, a top portion 34, a first side portion 36 and a second side portion 38. The bottom and top portions 32, 34 are arranged opposite to each other in a height direction H (cf. FIG. 1). The height direction H refers to a direction of the height of the battery cells 12 of the battery cell stack 10. Thus, the height direction H is orthogonal to the staking direction S. The first and second side portions 36, 38 are arranged opposite to each other in the stacking direction S and interconnect the bottom portion 32 and the top portion 34 in the height direction H.

The housing 30 further has a side opening 40 through which the battery cell stack 10 is insertable into the housing 30 in an insertion direction I. The insertion direction I, as shown in FIG. 1, is orthogonal to the stacking direction S and orthogonal to the height direction H. In other words, the housing 30 provides a structure enclosing the inserted or accommodated battery cell stack 10, when viewed in the insertion direction I (see FIG. 2). For example, the housing 30 is a closed structure, e.g. a closed frame, with an insertion opening (the side opening 40), when viewed in the insertion direction I. Due to this structure, bending of the side portions 36, 38 in the stacking direction S, e.g. during assembly or operation of the battery module 100, may be prevented or at least reduced.

At the side opposite to the side opening 40 in the insertion direction I, the housing 30 may be closed, e.g. closed by a wall extending from the bottom portion 32 to the top portion 34 in the height direction H. Due to the closure of the side opposite to the side opening 40, the wall may act as a barrier when the battery cell stack 10 is inserted into the housing 30. Accordingly, the assembly thereof is facilitated and the robustness of the battery module 100 may be enhanced.

In one or more embodiments and as shown in FIGS. 1 and 2, the housing 30 includes another side opening at the side opposite to the side opening 40 in the insertion direction I and through which the battery cell stack 10 is also insertable into the housing 30 in an insertion direction I. The side openings 40 may be formed identically or nearly identically. Accordingly, the battery cell stack 10 is insertable into the housing 30 from both sides (e.g., opposite sides), if required or desired, thereby facilitating the assembly of the battery module 100. In addition, less space in the insertion direction I is required or desired. In other words, the length of the battery cell stack 10 may correspond to the length of the housing 30 in the insertion direction I such that the battery cell stack 10 may be arranged flush (or less than flush, i.e. the housing 30 protrudes from the battery cell stack 40) with the housing 30. Accordingly, a compact battery module 100 may be provided. The length of the housing 30 in the insertion direction I may be important such that the battery cell stack 10 may be accommodated in (e.g., accommodated entirely in) the housing 30, at least with respect to the insertion direction I, as shown in FIG. 2.

As further shown in the FIGS. 1 and 2, the top portion 34 of the housing 30 has an opened section 42 overlaying the electrode terminals 14 and the venting valves 16 of the plurality of battery cells 12 of the battery cell stack 10 when the battery cell stack 10 is accommodated in the housing 30 (cf. FIG. 2). In other words, the opened section 42 is configured such that the electrode terminals 14 and the venting valves 16 of the plurality of battery cells 12 of the accommodated battery cell stack 10 are exposed when viewed from above, i.e. viewed from the top portion 34 of the housing 30. Due to the exposure of the electrode terminals 14 and the venting valves 16, which may be regarded as the functional areas of the battery cells 12, the electrode terminals 14 may be connected more easily subsequently and the venting valves 16 are not blocked by the housing 30 in case of a venting event in which the venting of the battery cell 12 via the venting valve 16 is required or desired. The opened section 42 is encompassed by the top portion 34 in the insertion direction I, e.g. by one or more bars extending between the side portions 36, 38 in the stacking direction S. In other words, despite the opened section 42 providing access to the functional areas of the battery cells 12, the top portion 34 increases rigidity and stiffness of the housing 30 against potential bending of the side portions 36, 38. Accordingly, bending of the side portions 36, 38 of the housing 30 can be prevented or at least reduced and, thus, the service life of the battery module 100 can be increased. The opened section 42 can make it easier to insert or remove the cell stack 10 into or from the housing 30.

As shown in FIGS. 1 and 2, the opened section 42 may include three slit-like openings 44 extending through (e.g., extending entirely through) the top portion 34 in the stacking direction S. Two of the three slit-like openings are formed so as to overlay the respective rows of electrode terminals 14, i.e. one slit-like opening 44 for each row of electrode terminals 14, and the remaining slit-like opening of the three slit-like openings 44 is formed so as to overlay the venting valves 16 of the plurality of battery cells 12 of the battery cell stack 10 when the battery cell stack 10 is accommodated in the housing 30. In other words, the top portion 34 of the housing 30 includes two outer and two inner bars extending from one of the side portions 36, 38 to the opposite side 36, 38 in the stacking direction S, such that each slit-like opening 44 is formed between two adjacent bars. The more connections of the top portion 34 in the stacking direction S are provided, e.g. the use of additional bars to provide three slit-like openings 44, the more rigidity and stiffness of the housing 30 against potential bending of the side portions 36, 38 is provided, while still ensuring that the electrode terminals 14 and the venting valves 16 are exposed when viewed from above, i.e. from the top portion 34. The slit-like openings 44 are arranged parallel to each other.

As further depicted in FIGS. 1 and 2, the housing 30 includes a cooling plate 48 on the bottom portion 32. The cooling plate 48 enhances heat dissipation. The cooling plate 48 is on an inner side of the bottom portion 32, i.e. the surface of the bottom portion 32 facing the accommodated battery cell stack 10. In other words, the cooling plate 48 is between the bottom portion 32 of the housing 30 and the accommodated battery cell stack 10. Accordingly, the transmission of heat in the battery module 100, e.g. heat generated by the operation of the battery cells 12, towards the outside is further enhanced due to the positioning of the cooling plate 48, thereby reducing the amount of swelling of the battery cells 12, and, thus, the amount of bending of the side portions 36, 38 of the housing 30. However, the present disclosure is not limited thereto and the cooling plate 48 may not be provided.

Referring to FIG. 3, which is a schematic enlarged view of III shown in FIG. 2, the enlarged cross section of one of the end sections of the battery module 100 in the stacking direction S, shows each of the side portions 36, 38 of the housing 30 includes a recess 46 for receiving the respective compressed elastic element 20 when the battery cell stack 10 is accommodated in the housing 30. The compressible elastic elements 20 are compressed during handling of the battery cell stack 10 at the force distribution plates 18, e.g. handling with a pliers device, such that the extension of the battery cell stack 10 in the stacking direction S is reversibly reduced until the battery cell stack 10 is accommodated in the housing 30. The compressible elastic elements 20 provide a restoration or opposing force against the side portions 36, 38 of the housing 30 to ensure a firm seating of the accommodated battery cell stack 10. Accordingly, the assembly of the battery module 100 is facilitated and the service life thereof is improved.

The recesses 46 are configured to provide further space in the stacking direction S for inserting the battery cell stack 10 into the housing 30, thereby further facilitating the assembly of the battery module 100. Each of the recesses 48 has a depth of more than 5 percent and less than 20 percent of the thickness of the respective side portion 36, 38 in the stacking direction S. For example, the housing 30 and the recesses 46 are designed such that the compressible elastic elements 20 are compressed when the battery cell stack 10 is accommodated in the housing 30 by at least 10 percent and up to 50 percent with respect to the length of the compressible elastic element 20 in the rest position (e.g., when the compressible elastic elements 20 are not compressed). However, the present disclosure is not limited thereto and the recesses 46 may not be provided.

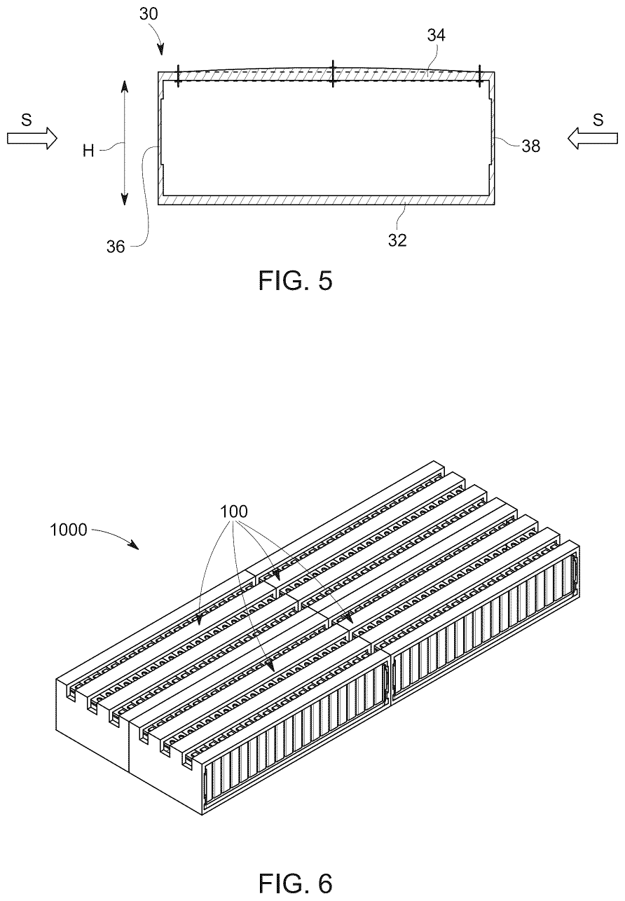

FIG. 4 is a schematic perspective view of a housing 30 according to one or more embodiments and FIG. 5 is a schematic cross section of the housing 30 shown in FIG. 4. As shown in the FIGS. 4 and 5, the top portion 34 may have a convex shape. In other words, the middle section of the top portion 34 in the stacking direction S has a thickness greater than a thickness of the ends (e.g., opposite ends) of the top portion 34 in the stacking direction S (cf. FIG. 5). At least one of (or each of) the bars extending between the side portions 36, 38 includes the convex shape (see FIG. 4). Due to the convex shape, the risk of bending of the side portions 36, 38 may be further reduced. The top portion 34 includes a single convex shape arranged at one surface, e.g. the outer surface as shown in FIGS. 4 and 5, or a double convex shape arranged on both the inner and the outer surfaces (e.g., opposite surfaces). The convex shape is formed such that the middle section of the top portion 34 in the stacking direction S has a thickness of at least 5 percent and less 25 percent greater than a thickness of the end portions of the top portion 34 in the stacking direction S. However, the present disclosure is not limited thereto and the convex shape may not be provided. For example, the bars may also be planar.

The housing 30 may include (e.g., may be made of) plastics or a hybrid combination including plastics. Due to the closed structure of the housing 30, the rigidity and stiffness thereof are increased to such an extent that materials with less mechanical resilience as compared to other metals used in the art, such as aluminum, may be used. In contrast to metals, plastics are insulating, thereby reducing the risk of current leakage or short circuiting. The mechanical properties of plastics and aluminum are shown in the following Table 1.

TABLE 1
Mechanical properties of plastics and aluminum

| Mechanical properties of plastics | | Mechanical properties of aluminum | |
|---|---|---|---|
| Elasticity | 1.43e+10 | Elasticity | 6.9e+10 |
| modulus | [pa] | modulus | [pa] |
| Poisson's ratio | 3.5e−01 | Poisson's ratio | 3.3e−01 |
| | [dimensionless] | | [dimensionless] |
| Density | 1.626e+03 | Density | 2.7e+03 |
| | [kg/m\hat{ }3] | | [kg/m\hat{ }3] |
| Ultimate tensile | 1.15e+08 | Ultimate tensile | 3.1e+08 |
| stress | [pa] | stress | [pa] |
| Tensile yield | 1.3e+08 | Tensile yield | 2.76e+08 |
| stress | [pa] | stress | [pa] |
| Compressive | 1.15e+08 | Compressive | 2.76e+08 |
| yield stress | [pa] | yield stress | [pa] |

FIG. 6 is a schematic perspective view of the battery system 1000 including four battery modules 100 shown in FIG. 1. The plurality of battery modules 100 can be adjacent to each other in a modular manner, e.g. a grid-like arrangement. In other words, the battery modules 100 may be adjacent to each other in the stacking direction S and in the insertion direction I. As shown in FIG. 6, the battery modules 100 may be in a 2×2 grid-like arrangement. Accordingly, a cost-effective and space saving battery system 1000 with high service life may be provided in a modular manner. For example, the venting channels provided by the slit-like opening 44 covering the venting valves 16 of each battery module 100 may be fluidly connected with the respective venting channel of an adjacent battery module in the stacking direction S such that the venting channels may be more easily achieved by the battery system 1000 and without requiring any further space in the height direction H. In addition, the rows of electrode terminals 14 of adjacent battery modules in the stacking direction S may be interconnected with greater ease as well, if necessary or desired. However, the battery system 1000 is not limited to the depicted number of battery modules 100 and may include any number of battery modules 100 in any arrangement as required or desired by a particular case.

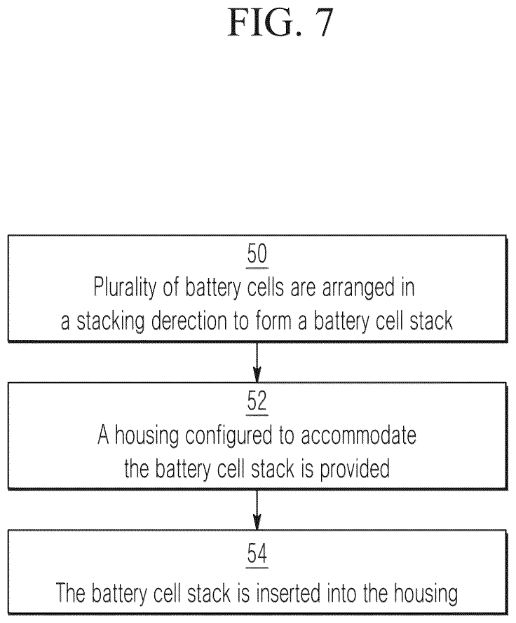

FIG. 7 illustrates a schematic flow chart of a method for assembling the battery module 100 shown in FIG. 1 according to one or more embodiments.

According to a first step 50, a plurality of battery cells are arranged in a stacking direction S to form the above-mentioned battery cell stack 10.

According to a second step 52 of the method, a housing 30 configured to accommodate the battery cell stack 10 is provided. The housing 30 refers to the above-mentioned housing 30. The housing 30 includes a bottom portion 32, a top portion 34, two side portions 36, 38 arranged opposite to each other with respect to the stacking direction S and interconnecting the bottom portion 32 and the top portion 34 in a height direction H and a side opening 40 through which the battery cell stack 10 is insertable into or removable from the housing 30 in an insertion direction I. The insertion direction I is orthogonal to the stacking direction S and orthogonal to the height direction H. The top portion 34 includes an opened section 42 to overlay the electrode terminals 14 and the venting valves 16 of the plurality of battery cells 12 of the battery cell stack 10 when the battery cell stack 10 is accommodated in the housing 30, as shown in FIG. 2, for example.

According to a third step 54 of the method, the battery cell stack 10 is inserted into the housing 30 through the side opening 40 in the insertion direction I, as shown in FIG. 1, for example.

Aspects and features of the present disclosure are not limited to the above-described aspects and features, and other aspects and features not mentioned herein can be clearly understood by those skilled in the art from the description of the present disclosure and the following claims.

Although embodiments have been disclosed herein, and specific terms employed, they are used and are to be interpreted in a generic and descriptive sense and not for purpose of limitation. Accordingly, it will be understood by those of ordinary skill in the art that various changes in form and details may be made without departing from the spirit and scope of the present disclosure as set forth in the following claims and their equivalents.

### REFERENCE SIGNS

10 battery cell stack
12 battery cells
14 electrode terminals
16 venting valve
18 force distribution plate
20 compressible elastic element
30 housing
32 bottom portion
34 top portion
36 first side portion
38 second side portion
40 side opening
42 opened section
44 slit-like openings
46 recess
48 cooling plate
50 first method step—providing a battery cell stack
52 second method step—providing a housing
54 third method step—inserting the battery cell stack
100 battery module
1000 battery system
S stacking direction
I insertion direction
H height direction

What is claimed is:

1. A battery module comprising:
a battery cell stack comprising a plurality of battery cells arranged in a stacking direction; and
a housing configured to accommodate the battery cell stack,
wherein the housing comprises:
a bottom portion;
a top portion;
two side portions arranged opposite to each other in the stacking direction and interconnecting the bottom portion and the top portion in a height direction; and
a side opening through which the battery cell stack is insertable into the housing in an insertion direction, the insertion direction being orthogonal to the stacking direction and being orthogonal to the height direction, and
wherein the top portion has an opened section overlaying electrode terminals and venting valves of the plurality of battery cells of the battery cell stack.

2. The battery module as claimed in claim 1, wherein the opened section comprises a slit-like opening extending through the top portion in the stacking direction.

3. The battery module as claimed in claim 2, wherein the slit-like opening comprises three slit-like openings, wherein at least two slit-like openings of the three slit-like openings overlay the electrode terminals and at least one slit-like opening of the three slit-like openings overlays the venting valves of the plurality of battery cells of the battery cell stack.

4. The battery module as claimed in claim 1, wherein the opened section extends through the top portion in the stacking direction.

5. The battery module as claimed in claim 1, wherein the battery cell stack further comprises a force distribution plate and a compressible elastic element, the force distribution plate and the compressible elastic element each arranged at opposite ends of the battery cell stack in the stacking direction.

6. The battery module as claimed in claim 5, wherein the compressible elastic element comprises degressive springs.

7. The battery module as claimed in claim 5, wherein each of the side portions of the housing comprises a recess configured to receive the compressible elastic element.

8. The battery module as claimed in claim 1, wherein the housing further comprises a cooling plate on the bottom portion.

9. The battery module as claimed in claim 1, wherein the bottom portion, the top portion, and the side portions of the housing are integrally connected to each other in a fabric-conclusive manner.

10. The battery module as claimed in claim 1, wherein the housing comprises plastics or a hybrid combination comprising plastics.

11. The battery module as claimed in claim 1, wherein the top portion comprises a convex shape.

12. A battery system comprising a plurality of battery modules as claimed in claim 1.

13. An electric vehicle comprising the battery module and/or the battery system as claimed in claim 12.

14. A method for assembling a battery module, the method comprising:
arranging a plurality of battery cells in a stacking direction to form a battery cell stack; and
inserting the battery cell stack into a housing, wherein the housing comprises:
a bottom portion;
a top portion;
two side portions arranged opposite to each other in the stacking direction and interconnecting the bottom portion and the top portion in a height direction; and
a side opening through which the battery cell stack is insertable into the housing in an insertion direction, the insertion direction being orthogonal to the stacking direction and being orthogonal to the height direction,
wherein the top portion comprises an opened section overlaying electrode terminals and venting valves of the plurality of battery cells of the battery cell stack.

15. A housing configured to accommodate a battery cell stack comprising a plurality of battery cells, the housing comprising:
a bottom portion;
a top portion; and
two side portions arranged opposite to each other in a stacking direction of the plurality of battery cells of the battery cell stack, interconnecting the bottom portion and the top portion in a height direction, and having a side opening through which the battery cell stack is insertable into the housing in an insertion direction, the insertion direction being orthogonal to the stacking direction and being orthogonal to the height direction,
wherein the top portion comprises an opened section overlaying electrode terminals and venting valves of the plurality of battery cells of the battery cell stack.
